(19) United States
(12) Patent Application Publication
(10) Pub. No.: US 2019/0079288 A1
(43) Pub. Date: Mar. 14, 2019

(54) HEAD MOUNTED DISPLAY SYSTEM AND IMAGE DISPLAY METHOD THEREOF

(71) Applicant: HTC Corporation, Taoyuan City (TW)

(72) Inventors: Cheng-Hsi Liu, Taoyuan City (TW); Chia-Chu Ho, Taoyuan City (TW); Min-Chi Chung, Taoyuan City (TW)

(73) Assignee: HTC Corporation, Taoyuan City (TW)

(21) Appl. No.: 15/703,944

(22) Filed: Sep. 13, 2017

(51) Int. Cl. G02B 27/01; G02B 27/00; G06F 3/01

(52) U.S. Cl. CPC G02B 27/017; G02B 27/0093; G06T 19/006; G02B 2027/014; G06F 3/011

(57) ABSTRACT

A head-mounted display (HMD) system and an image display method thereof are provided. The HMD system has an HMD apparatus and a handheld electronic apparatus. The HMD apparatus has a connector and generates a multi-axis positioning information according to motion status. The handheld electronic apparatus receives the multi-axis positioning information via the connector and provides a display image data corresponding to the multi-axis positioning information. The HMD apparatus receives the display image data and executes an image display operation according to the display image data.

### BACKGROUND OF THE INVENTION

### Field of the Invention

The invention relates to a head-mounted display (HMD) system and an image display method thereof, and more particularly, to an all-in-one (AIO) HMD system and an image display method thereof.

### Description of Related Art

With the rapid development of electronic products, providing a high-quality image display interface and increasing the display effects of virtual reality (VR) and augmented reality (AR) have become the objects of next-generation display apparatuses.

In a head-mounted display (HMD) apparatus, an all-in-one (AIO) design is the current development trend in the art. However, based on the display effects of VR and AR, the amount of calculation related to the display information required is relatively large, and therefore under the AIO design structure, to make the speed of image transformation catch up to the speed of limb movements of the user is a significant challenge in design. Moreover, in prior art, when the design of the HMD apparatus is complete, only the function and efficacy of immobilization can be obtained, and when the user wants to change (increase) the efficacy of the HMD apparatus, the existing HMD apparatus cannot be upgraded, and another HMD apparatus needs to be bought, such that waste of resources occurs.

### SUMMARY OF THE INVENTION

The invention provides a head-mounted display (HMD) system and an image display method thereof that can reduce the time needed for image processing to increase the quality of display.

The HMD system of the invention has an HMD apparatus and a handheld electronic apparatus. The HMD apparatus has a connector and generates a multi-axis positioning information according to motion status. The handheld electronic apparatus is coupled to the HMD apparatus via the connector and receives the multi-axis positioning information and provides a display image data corresponding to the multi-axis positioning information. In particular, the HMD apparatus receives the display image data and executes an image display operation according to the display image data.

The image display method of the invention is suitable for an HMD apparatus, and includes generating a multi-axis positioning information according to the motion status of the HMD apparatus; providing a multi-axis positioning information to a handheld electronic apparatus via a connector; providing a display image data according to the multi-axis positioning information using the handheld electronic apparatus; and making the HMD apparatus execute an image display operation according to the display image data.

Based on the above, the invention provides an all-in-one HMD system that makes an HMD apparatus execute the computing operation of a multi-axis positioning information and provides a display image data corresponding to the multi-axis positioning information with the handheld electronic apparatus to make the HMD apparatus perform an image display operation. A processing operation of related information is performed by having the apparatuses work in conjunction, such that the HMD system can more rapidly complete the processing of display image to effectively increase the display quality of the image thereof. Moreover, an embodiment of the invention provides a modular application apparatus and the HMD apparatus can be upgraded via a mechanism of switching the application apparatus to reduce waste of resources.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a schematic of a head-mounted display (HMD) system of an embodiment of the invention.

FIG. 2 shows a schematic of an embodiment of an HMD apparatus of an embodiment of the invention.

FIG. 3 shows a schematic of another embodiment of an HMD apparatus of an embodiment of the invention.

FIG. 4 shows a schematic of an embodiment of an HMD system of an embodiment of the invention.

FIG. 5 shows a schematic of yet another embodiment of an HMD apparatus of an embodiment of the invention.

FIG. 6 shows a flow chart of an image display method of an embodiment of the invention.

FIG. 7 shows a schematic of the operating process of an HMD system of an embodiment of the invention.

### DESCRIPTION OF THE EMBODIMENTS

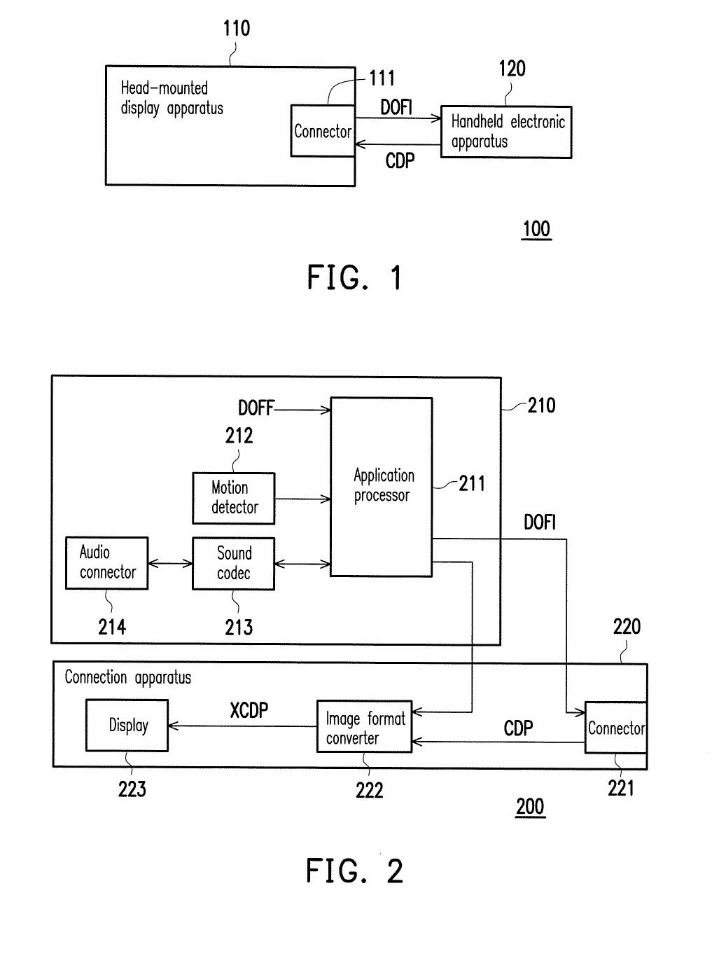

Referring to FIG. 1, FIG. 1 shows a schematic of a head-mounted display (HMD) system of an embodiment of the invention. The HMD system 100 includes an HMD apparatus 110 and a handheld electronic apparatus 120. The HMD apparatus 110 has a connector 111 and is connected to the handheld electronic apparatus 120 via the connector 111. The HMD apparatus 110 can detect the motion status thereof and generate multi-axis positioning information DOFI according to the detected motion status.

The HMD apparatus 110 sends the generated multi-axis positioning information DOFI to the handheld electronic apparatus 120 via the connector 111. After the handheld electronic apparatus 120 receives the multi-axis positioning information DOFI, a corresponding display image data CDP can be generated according to the multi-axis positioning information DOFI, and the display image data CDP can be sent to the HMD apparatus 110 via the connector 111. As a result, the HMD apparatus 110 can perform an image display operation according to the received display image data CDP.

More specifically, the HMD apparatus 110 can perform a multi-degree of freedom (DOF) equation calculation for the resulting motion status to generate the multi-axis positioning information DOFI. In particular, the multi-DOF equation can be a 3DOF equation, a 6DOF equation, or other different DOF equations known to those having ordinary skill in the art.

Moreover, the connector 111 can be a Type-C universal serial bus (USB) connector or other types of connectors that can transmit general information and image information and are known to those having ordinary skill in the art.

It can be known from the descriptions above that, in an embodiment of the invention, the HMD system 100 makes the HMD apparatus 110 and the handheld electronic apparatus 120 respectively perform a computing operation of the multi-axis positioning information DOFI and the display image data CDP. As a result, when the apparatuses work in conjunction, the display image data CDP correspondingly generated according to the motion status of the HMD apparatus 110 can be more rapidly generated, and the performance of the HMD apparatus 110 can be effectively increased.

Moreover, the handheld electronic apparatus 120 in an embodiment of the invention can be a smart phone or other electronic apparatuses that are portable and have computing capability. When used with the handheld electronic apparatus 120, the HMD system 100 of an embodiment of the invention is more mobile, and the ease of use thereof is effectively increased.

Referring to FIG. 2 next, FIG. 2 shows a schematic of an embodiment of an HMD apparatus of an embodiment of the invention. The HMD apparatus 200 includes an application apparatus 210 and a connection apparatus 220. The application apparatus 210 and the connection apparatus 220 are coupled to each other. The application apparatus 210 includes an application processor 211, a motion sensor 212, a sound codec 213, and an audio connector 214. The application processor 211 is used for processing related information of applications executed by the HMD apparatus 200. Moreover, the application processor 211 is coupled to the motion sensor 212. In particular, the motion sensor 212 detects the motion status of the HMD apparatus 200, including various related information such as posture, moving distance, turning angle, moving speed, and acceleration. The application processor 211 receives the motion status generated by the motion sensor 212 and performs an arithmetic operation for the motion status of the HMD apparatus 200.

The application processor 211 further receives related information of the multi-DOF equation DOFF and performs an arithmetic operation of the multi-DOF equation DOFF for the motion status of the HMD apparatus 200 to generate the multi-axis positioning information DOFI. The multi-axis positioning information DOFI is sent to the connector 221 via the application processor 211, and the multi-axis positioning information DOFI is sent to the corresponding handheld electronic apparatus via the connector 221.

The application processor 211 is also coupled to the sound codec 213, and the sound codec 213 is used for performing a coding or decoding operation on the sound signal and sending the coded or decoded sound signal to the audio connector 214 or the application processor 211. In particular, the audio connector 214 can be connected to an external electronic apparatus (not shown), and a transmission or receiving operation of an audio signal between the audio connector 214 and the external electronic apparatus can be performed.

Here, the sound codec 213 and the audio connector 214 of an embodiment of the invention can be made by adopting a codec circuit and an audio jack for a sound signal known to those having ordinary skill in the art and are not particularly limited.

Moreover, in an embodiment of the invention, the connection apparatus 220 includes a connector 221, an image format converter 222, and a display 223. The connector 221 is coupled to the image format converter 222, and the image format converter 222 is coupled to the display 223 and the application processor 211. When the application processor 211 provides the generated multi-axis positioning information DOFI to the handheld electronic apparatus via the connector 221, the handheld electronic apparatus can generate the display image data CDP in correspondence to the received multi-axis positioning information DOFI and send the display image data CDP to the image format converter 222 via the connector 221. The image format converter 222 performs an image format conversion operation for the display image data CDP to generate a converted image data XCDP. The image format converter 222 provides the converted image data XCDP to the display 223 such that the display 223 executes an image display operation according to the converted image data XCDP.

Here, the image format converter 222 is configured to convert display data between many different image formats, such as the display serial interface (DSI) format and the display port (DP) interface format known to those having ordinary skill in the art, and to convert the formats into the converted image data XCDP in high-definition multimedia interface (HDMI) format and make the display 223 execute a high-definition image display operation.

Here, the image format converter 222 can be made by adopting an image format conversion circuit known to those having ordinary skill in the art and is not particularly limited.

Moreover, the image format converter 222 is also coupled to the application processor 211. When the application processor 211 needs to perform an image display operation, the image information to be displayed can be sent to the image format converter 222 and an image data in high-quality multimedia interface format is generated to execute an image display operation on the display 223.

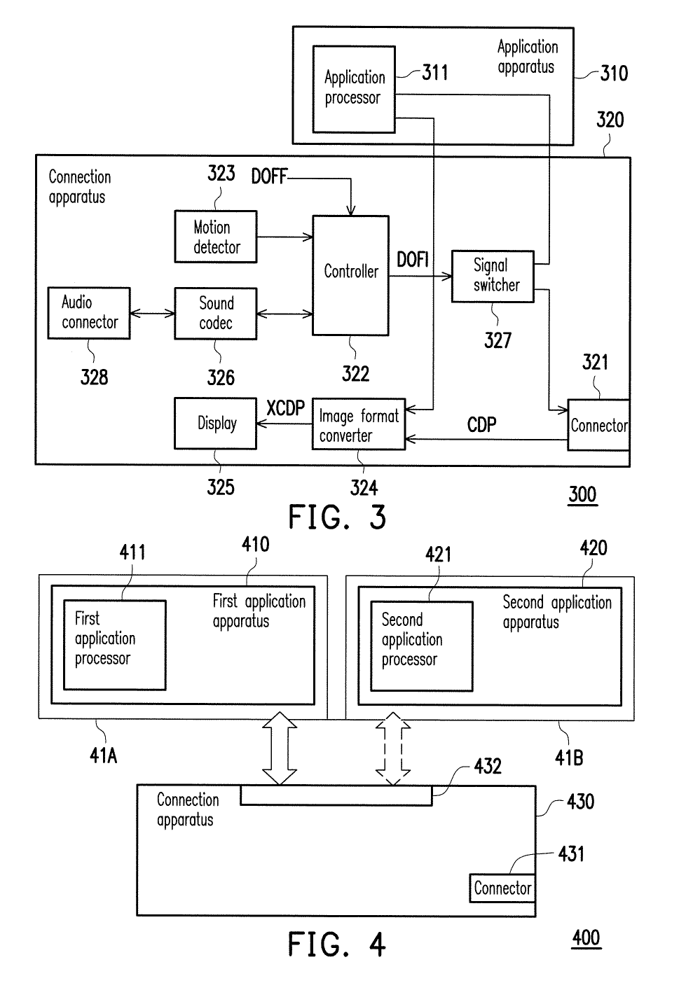

Next, referring to FIG. 3, FIG. 3 shows a schematic of another embodiment of an HMD apparatus of an embodiment of the invention. The HMD apparatus 300 includes an application apparatus 310 and a connection apparatus 320. The application apparatus 310 and the connection apparatus 320 are coupled to each other. The application apparatus 310 includes an application processor 311. The connection apparatus 320 includes a connector 321, a controller 322, a motion sensor 323, an image format converter 324, a display 325, a sound codec 326, a signal switcher 327, and an audio connector 328. In the application apparatus 310, the application processor 311 is used for processing related information of applications executed by the HMD apparatus 300. In the connection apparatus 320, the controller 322 is coupled to the motion sensor 323, the sound codec 326, and the signal switcher 327. The motion sensor 323 detects the motion status of the HMD apparatus 300 and provides related information of the resulting motion status to the controller 322. The controller 322 also receives related information of the multi-DOF equation DOFF and performs a multi-DOFF equation DOFF calculation for the motion status to generate a multi-axis positioning information DOFI.

The multi-axis positioning information DOFI generated by the controller 322 can be sent to the connector 321 via the signal switcher 327. In particular, the signal switcher 327 is coupled between the application processor 311, the controller 322, and the connector 321 for switching and to allow data transmission between the controller 322 and the connector 321 or allow data transmission between the processor 311 and the connector 321.

The controller 322 can send the multi-axis positioning information DOFI to the connector 321 via the signal switcher 327 and make the handheld electronic apparatus connected to the connector 321 receive the multi-axis positioning information DOFI. The handheld electronic apparatus can generate a corresponding display image data CDP according to the multi-axis positioning information DOFI. For instance, the handheld electronic apparatus can learn that the field of view of the user covers the image in a scene of virtual reality (VR) according to the multi-axis positioning information DOFI and generate the display image data CDP accordingly. The handheld electronic apparatus sends the display image data CDP to the image format converter 324 via the connector 321.

The image format converter 324 is coupled to the connector 321, the application processor 311, and the display 325. When the image format converter 324 receives the display image data CDP, a conversion operation of image format can be executed for the display image data CDP, and a converted image data XCDP satisfying the image format for the display 325 can be generated. As a result, the display 325 can perform an image display operation according to the converted image data XCDP.

It should be mentioned that, the image format converter 324 can also receive an image data provided by the application processor 311 and make the display 325 perform a corresponding display operation.

Referring to FIG. 4, FIG. 4 shows a schematic of an embodiment of an HMD system of an embodiment of the invention. In an HMD apparatus 400 of FIG. 4, a first application apparatus 410 including a first application processor 411 can be disposed in a first application module 41A. The first application module 41A is detachably coupled via a connector 432 on a connection apparatus 430. Moreover, a second application module 41B can further be disposed in the HMD system 400, wherein the second application module 41B includes a second application apparatus 420 having a second application processor 421. Here, the second application processor 421 and the first application processor 411 are different, and the second application module 41B can also be detachably coupled via the connector 432 on the connection apparatus 430.

Specifically, when the first application module 41A and the connector 432 are no longer coupled, the first application module 41A and the connection apparatus 430 are physically isolated, and at this point, a connection between the second application module 41B and the connector 432 can be established. As a result, the second application processor 421 replaces the first application processor 411.

The first application module 41A and the second application module 41B can, for instance, be designed as circuit board modules having a gold finger connector, and the connector 432 is a corresponding connection apparatus. Of course, the form of connection of the connector 432 with the first application module 41A and the second application module 41B can also be implemented by any other known connection structure and is not particularly limited.

The operation can allow the user to change the application processor in the HMD apparatus 400 according to actual requirement. Similarly, it can be known that, by replacing with a different application module, the HMD apparatus 400 can be upgraded.

Moreover, the connection apparatus 430 further includes a connector 431. The connector is used for connecting a handheld electronic apparatus (such as the handheld electronic apparatus 120 shown in FIG. 1). The connector 431 can be a Type-C USB connector.

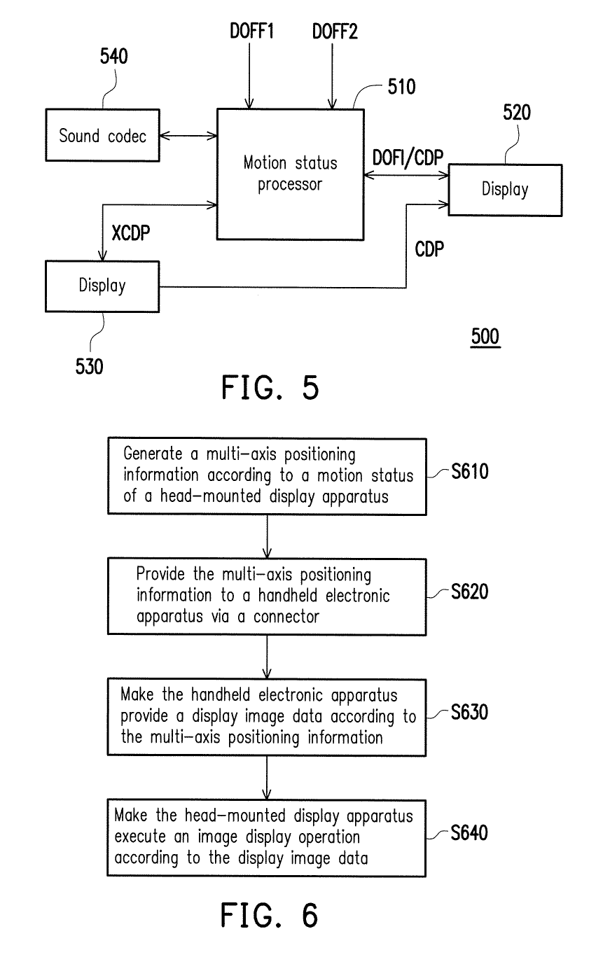

Referring to FIG. 5, FIG. 5 shows a schematic of another embodiment of an HMD apparatus of an embodiment of the invention. An HMD apparatus 500 includes a motion status processor 510, a connector 520, a display 530, and a sound codec 540. The motion status processor 510 can detect the motion status of the HMD apparatus 500 and perform a multi-DOF equation calculation for motion status to generate the multi-axis positioning information DOFI. In the present embodiment, the motion status processor 510 can receive different multi-DOF equations DOFF1 and DOFF2 and generate the multi-axis positioning information DOFI accordingly. The multi-DOF equations DOFF1 and DOFF2 can respectively be a 3DOF equation and a 6DOF equation.

The motion status processor 510 provides the multi-axis positioning information DOFI to a handheld electronic apparatus (such as the handheld electronic apparatus 120 in FIG. 1) via the connector 520. The handheld electronic apparatus provides the display image data CDP to the connector 520 in correspondence to the multi-axis positioning information DOFI. In the present embodiment, the display image data CDP can be directly provided to the display 530 via the connector 520, and the display 530 can perform an image display operation according to the display image data CDP. Alternatively, the display image data CDP can also be provided to the motion status processor 510 via the connector 520. The motion status processor 510 can perform a conversion operation of image format for the display image data CDP to generate a converted image data XCDP. The motion status processor 510 sends the converted image data XCDP to the display 530 to make the display 530 perform an image display operation according to the converted image data XCDP.

Moreover, the motion status processor 510 is coupled to the sound codec 540. The sound codec 540 performs a coding or decoding operation for a sound signal and allows the motion status processor 510 to receive a sound signal or execute a play operation of a sound.

It should be mentioned that, the controller, application processor, and motion status processor in the plurality of embodiments above can all be processors having computing power. Alternatively, the controller, application processor, and motion status processor can be designed by a hardware description language (HDL) or any other design methods of a digital circuit known to those having ordinary skill in the art, and are hardware circuits implemented by a field programmable gate array (FPGA), complex programmable logic device (CPLD), or application-specific integrated circuit (ASIC).

Referring to FIG. 6, FIG. 6 shows a flow chart of an image display method of an embodiment of the invention. In particular, in step S610, a multi-axis positioning information is generated according to the motion status of an HMD apparatus; in step S620, a multi-axis positioning information is provided to the handheld electronic apparatus via a connector; in step S630, the handheld electronic apparatus provides a display image data according to the multi-axis positioning information; and in step S640, the HMD apparatus executes an image display operation according to the display image data.

The embodiment details of the steps above are described in detail in the above embodiments and are not repeated herein.

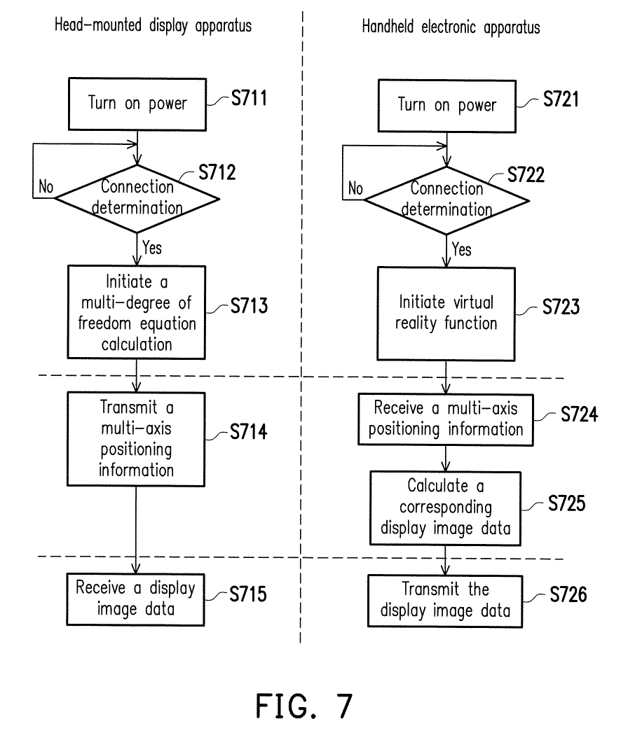

Referring to FIG. 7, FIG. 7 shows a schematic of the operating process of an HMD system of an embodiment of the invention. In particular, an HMD apparatus is powered on in step S711, and whether a connection with a handheld electronic apparatus is established is determined in step S712. At the same time, the handheld electronic apparatus is powered on in step S721, and whether a connection is established with the HMD apparatus is determined in step S722. In particular, the determination of connection in step S712 and step S722 can be performed at the same time, and the handheld electronic apparatus and the HMD apparatus can be implemented by, for instance, Type-C USBs.

When the handheld electronic apparatus and the HMD apparatus are determined to be connected to each other in both step S712 and S722, the HMD apparatus can initiate the calculation of multi-DOF equation in step S713. At the same time, the handheld electronic apparatus can also initiate the function of VR in step S723. The HMD apparatus can detect the motion status thereof and execute the calculation of a multi-DOF equation for the motion status to generate a multi-axis positioning information (step S714). The handheld electronic apparatus receives the multi-axis positioning information generated by the HMD apparatus (step S724), and a display image data corresponding to the multi-axis positioning information is generated via an application executing the function of VR (step S725).

In step S726, the handheld electronic apparatus sends a display image data to the HMD apparatus. In step S715, the HMD apparatus receives the display image data generated by the handheld electronic apparatus and performs an image display operation accordingly.

Based on the above, in an embodiment of the invention, since the HMD apparatus and the handheld electronic apparatus respectively execute a processing operation of different information, the acquisition operation of display image data can be rapidly completed to increase the image display performance of the HMD system.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

1. A head-mounted display (HMD) system, comprising:
an HMD apparatus having a connector, wherein the HMD apparatus generates a multi-axis positioning information according to a motion status; and
a handheld electronic apparatus coupled to the HMD apparatus via the connector and receiving the multi-axis positioning information and providing a display image data corresponding to the multi-axis positioning information,
wherein the HMD apparatus receives the display image data and executes an image display operation according to the display image data.

2. The HMD system of claim 1, wherein the HMD apparatus comprises:
an application apparatus, comprising:
a motion sensor obtaining the motion status; and
an application processor coupled to the motion sensor and performing a multi-degree of freedom (DOF) equation calculation for the motion status to generate the multi-axis positioning information; and
a connection apparatus coupled to the application apparatus and having a display, wherein the connection apparatus has the connector so as to be connected to the handheld electronic apparatus, the connection apparatus is used for transmitting the multi-axis positioning information to the handheld electronic apparatus and receiving the display image data and converting a format of the display image data to generate the converted image data, and making the display execute the image display operation according to the converted image data.

3. The HMD system of claim 2, wherein the application apparatus further comprises:
a sound codec coupled to the application processor and performing a coding or decoding operation for a sound signal.

4. The HMD system of claim 2, wherein the connection apparatus further comprises:
an image format converter coupled to the connector for converting the format of the display image data to generate the converted image data.

5. The HMD system of claim 1, wherein the connector is a Type-C universal serial bus connector.

6. The HMD system of claim 1, wherein the HMD apparatus comprises:
an application apparatus having a first application processor; and
a connection apparatus coupled to the application apparatus, comprising:
a motion sensor obtaining the motion status;
a controller coupled to the motion sensor and performing a multi-DOF equation calculation for the motion status to generate the multi-axis positioning information; and
an image format converter coupled to the connector for converting a format of the display image data to generate a converted image data; and
a display coupled to the image format converter to perform the image display operation according to the converted image data.

7. The HMD system of claim 6, wherein the connection apparatus further comprises:
a signal switcher coupled between the controller, the application processor, and the connector and choosing to send the multi-axis positioning information to the connector or choosing to send the converted image data to the application processor.

8. The HMD system of claim 6, wherein the connection apparatus further comprises:
a sound codec coupled to the controller and performing a coding or decoding operation for a sound signal.

9. The HMD system of claim 6, wherein the application apparatus is disposed in a first application module, and the first application module is detachably coupled to the connection apparatus.

10. The HMD system of claim 9, further comprising a second application module, wherein the second application module has a second application processor thereon, and the second application module is detachably coupled to the connection apparatus,
wherein when the first application module and the connection apparatus are physically isolated, the second application module is coupled to the connection apparatus, and the second application processor replaces the first application processor.

11. The HMD system of claim 1, wherein the HMD apparatus comprises:
a motion status processor detecting the motion status of the HMD apparatus and performing a multi-DOF equation calculation for the motion status to generate the multi-axis positioning information; and
a display coupled to the motion status processor,
wherein the motion status processor receives the display image data via the connector and makes the display perform the image display operation according to the display image data.

12. The HMD system of claim 11, wherein the HMD apparatus further comprises:
a sound codec coupled to the motion status processor and performing a coding or decoding operation for a sound signal.

13. The HMD system of claim 11, wherein the motion status processor further performs an image format conversion operation for the display image data to generate a converted image data, and the display performs the image display operation according to the converted image data.

14. An image display method suitable for an HMD apparatus, comprising:
generating a multi-axis positioning information according to a motion status of the HMD apparatus;
providing the multi-axis positioning information to a handheld electronic apparatus via a connector;
making the handheld electronic apparatus provide a display image data according to the multi-axis positioning information; and
making the HMD apparatus execute an image display operation according to the display image data.

15. The image display method of claim 14, wherein the step of generating the multi-axis positioning information according to the motion status of the HMD apparatus comprises:
performing a multi-DOF equation calculation for the motion status to generate the multi-axis positioning information.

16. The image display method of claim 14, wherein the step of making the HMD apparatus execute the image display operation according to the display image data comprises:
performing an image format conversion for the display image data to generate a converted image data; and
making the HMD apparatus execute the image display operation according to the converted image data.

17. The image display method of claim 14, wherein the converter is a Type-C universal serial bus connector.
